(19) United States
(12) Patent Application Publication
(10) Pub. No.: US 2009/0254311 A1
(43) Pub. Date: Oct. 8, 2009

(54) METHOD FOR MONITORING COMPUTER SYSTEM PERFORMANCE AND COMPUTER READABLE MEDIUM THEREOF

(76) Inventors: Yin-Hsong HSU, Sijhih City (TW); Su-Cheong MAC, Sijhih City (TW)

Correspondence Address: Hershkovitz & Associates, LLC, 2845 Duke Street, Alexandria, VA, 22314, US

(21) Appl. No.: 12/369,586

(22) Filed: Feb. 11, 2009

(30) Foreign Application Priority Data
Apr. 7, 2008 (TW) 97125188

(51) Int. Cl. G06F 15/00

(52) U.S. Cl. 702/186

(57) ABSTRACT

A method for administrating a computer system is disclosed, which includes the following steps of: the computer system conducts system administration at a first moment and records the information thereof. Next, the computer system again conducts system administration at a second moment and records the information thereof. Then, after being collected at the above two moments, the information is compared against each other to produce a comparison result. At last, the user is prompted in accordance with the comparison result.

### CROSS REFERENCE TO RELATED APPLICATIONS

This application claims the right of priority based on Taiwan Patent Application No. 097125188 entitled “Method for Monitoring computer System Performance and Computer Readable Medium thereof”, filed on Jul. 4, 2008, which is incorporated herein by reference and assigned to the assignee herein.

### FIELD OF INVENTION

The present invention relates to a method for administrating a computer system. Particularly, the information regarding the system administrations carried out at different moments is analyzed to prompt the user.

### BACKGROUND OF THE INVENTION

The number of software and Application installed on a computer will affect the performance of the computer system, which is particularly reflected by how long it takes to boot or to shut down the computer system. In this aspect, a number of measurement tools or profilers have been developed to monitor the system performance and to find out how software and Applications relate to the system performance.

Some conventional measurement tools or profilers, such as Mircrosoft's WINDOWS Performance Tools, could be downloaded from the Internet to analyze the performance of the computer system. However, these tools are not easy to use for ordinary users. Instead, IT Professionals need specific skills to input commands and to interpret the data generated from these tools. Therefore, an ordinary user cannot know the installation of whish software will affect the system performance. He cannot decide to uninstall which software to release the hardware resource and to restore the low system performance, either.

Therefore, it is desirable to have a new method to monitor the system performance at the installation of new Application or at some predetermined moments. It will be better if this method can analyze the performance data and help the user find out which installed Applications slow down the system performance.

### SUMMARY OF THE INVENTION

The present invention is to provide a method of administrating a computer system. In one aspect, after each installation of a new Application, the time required to complete the next system administration is measured and analyzed to investigate the relationship between the newly installed Application and the system performance and to prompt the user.

In one embodiment, disclosed is a method for administrating a computer system, which includes the following steps of: the computer system conducts system administration at a first moment and records the information thereof. Next, the computer system again conducts system administration at a second moment and records the information thereof. Then, after being collected at the above two moments, the information is compared against each other to produce a comparison result. At last, the user is prompted in accordance with the comparison result.

In another embodiment, disclosed is a computer readable medium embodying computer code on a computer system, where the computer code includes computer executable instructions configured for performing the method mentioned above.

The foregoing and other features of the invention will be apparent from the following more particular description of embodiments of the invention.

### BRIEF DESCRIPTION OF THE DRAWINGS

The present invention is illustrated by way of example and not intended to be limited by the figures of the accompanying drawing, in which like notations indicate similar elements.

FIG. 1a illustrates a computer according to an embodiment of the present invention; and

FIG. 2 is a flowchart of a method according to an embodiment of the present invention.

### DETAILED DESCRIPTION

In the following description, the “system administration” refers to, but is not limited to, the booting or the shutting-down of a computer system. For example, when booting a WINDOWS XP laptop computer, the operation system will have a series of booting stages and several booting procedures; but when shutting-down, the operation system has no shutting-down stage and carries out the shutting-down procedures only.

Note that the “shutting-down” of a computer system in this specification includes “power off”, “standby”, and “hibernation”. Each “Application” or “Application Program” may relate to a number of files, including files belonging to the Application or operation system files required for the execution of the Application. A “procedure” includes actions of accessing these related files of Applications.

In an embodiment, the system administration of the computer system 10 (e.g., a laptop computer, a desktop, or a workstation) could be carried out as the “booting” or the “shutting-down” to implement the present invention. Two “booting” (or two “shutting-down”) may be performed respectively at a first moment and subsequently at a second moment. The time interval between the first moment and the second moment is not critical in the present invention. Moreover, a “booting” may be carried out before or after a “shutting-down” in the embodiment.

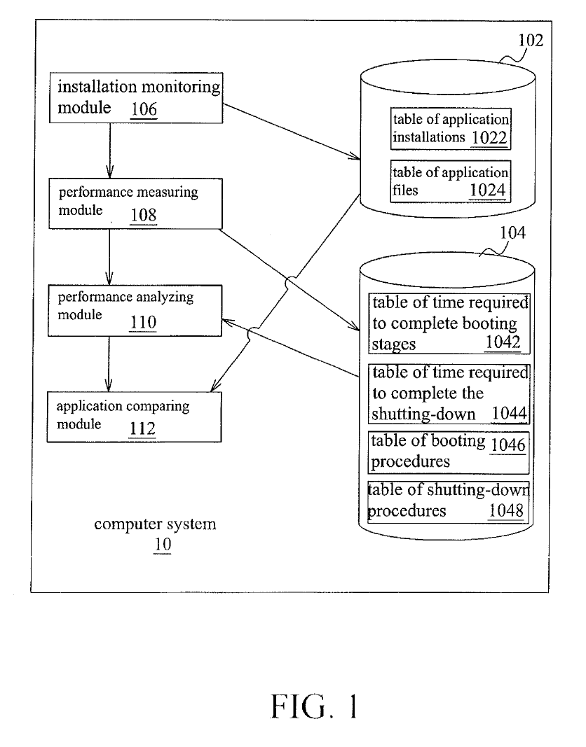

As shown in FIG. 1, the computer system 10 adopts the application database 102, the performance database 104, the installation monitoring module 106, the performance measuring module 108, the performance analyzing module 110, and the application comparing module 112. Particularly, a table of application installations 1022 and a table of application files 1024 are stored in the application database 102; a table of time required to complete booting stages 1042, a table of time required to complete the shutting-down 1044, a table of booting procedures 1046, and a table of shutting-down procedures 1048 are stored in the performance database 104. The databases and modules mentioned above could be embodied as software, hardware, or the combination thereof.

The application database 102 stores application installation information, which records the installation of a new Application between the first moment and the second moment in the table of application installation 1022 as well as files associated with the Application in the table of application files 1024. The application database 102 further stores application files information, which records all Applications that have been installed in the computer system 10 until the second moment in the table of application installation 1022, as well as files related to these Applications in the table of application files 1024.

Performance database 104 records the information regarding the system administrations conducted at the first moment and at the second moment. The information may record the time required to complete booting stages as the table 1042, the time required to complete the shutting-down as the table 1044, the booting procedures as the table 1046, and the shutting-down procedures as the table 1048.

Installation monitoring module 106 detects if there is a new Application installed during the time interval between the first moment and the second moment. In an embodiment, after the booting of the computer system 10, the installation monitoring module 106 is executed as a background job in the operating system for detecting the installation of any new Application. When an installation is detected, the installation monitoring module 106 informs the application database 102 to update the application installation information and application files information, and also make the performance measuring module 108 aware of the installation events.

Performance measuring module 108 could be implemented by conventional software already created by some software companies. For example, the performance measuring module 108 may be adopted as Microsoft's performance measuring tool, to obtain the information regarding the system administrations conducted at the first moment and at the second moment and to further record them in the performance database 104. The performance measuring module 108 could be activated at some predetermined moment. In another embodiment, as informed the installation event by the installation monitoring module 106, the performance measuring module 108 will be executed at the next system administration right after the installation event.

Performance analyzing module 110 consults the performance database 104 to analyze the time required to complete booting stages or the time required to complete the entire shutting-down.

Take the time required to complete booting stages for example. Performance analyzing module 110 compares the different time required to complete the entire booting or compares the different time required to complete a specific booting stage, in order to determine if the booting is “slow down”. In an embodiment, if the time difference is greater than a predetermine value, or exceeds a predetermined percentage, e.g., 10% of the first required time, then it could be concluded that the booting is “slow down” and the performance of the computer system 10 is getting low. Then the performance analyzing module 110 may further compare booting procedures of these two booting to find out any additional procedures or any existing procedures which may result in the low performance. The same approach may be applied to the shutting-down of the computer system 10, but there may not be “stages” for shutting-down. So the performance analyzing module 110 may simply compare the different times required to complete the entire “shutting-down” to determine if the shutting-down takes longer time. If yes, the performance analyzing module 110 may further compare procedures of these two shutting-down.

In an embodiment where the system administration is conducted as a booting, the application comparing module 112 further compares the application installations information stored in the application database 102 with the additional procedures found by the performance analyzing module 110 in these two booting, in order to identify the Application associated with the additional procedures and to inform the user with this result in a prompt message.

In another embodiment, the application comparing module 112 further compares the application files information stored in the application database 102 with the additional files accessed in a corresponding procedure found by the performance analyzing module 110 in these two booting, in order to identify, among all the Applications installed in the computer system 10, the Application associated with the additional files, and to inform the user with this result in a prompt message. Note that these two embodiments can both apply when the system administration is conducted as a shutting-down.

The following example may further explain the present invention. In this example, a WINDOWS XP computer has undergone booting twice as the system administrations i.e., the first booting at 9 AM and the second booting at 4 PM. The computer system 10 was shut down at least once before 4 PM. More important, Application 3 was installed on the computer system 10 between the first booting at 9 AM and the second booting at 4 PM. Note that the system administrations for the present invention could be conducted as the booting or the shutting-down, and there is no specific time interval between this two system administrations.

Table 1 exemplifies the table of application installations; Table 2 exemplifies the table of application files, showing all Applications which have been installed on the computer 10 before 4 PM and files related to these Applications. Note that a directory means all files in this directory in Table 2.

TABLE 1
(Table of application installation)

| Application | Installation Time |
|---|---|
| Application 3 | 2008/3/27 09:30:01 |

TABLE 2
(Table of application files)

| Application | Related Files |
|---|---|
| Application 1 | C:\Program Files\App1\ |
| | C:\Windows\system32\lib1.dll |
| | C:\Windows\system32\lib2.dll |
| Application 2 | C:\Vendor2\App2\ |
| Application 3 | C:\Vendor3\App3\ |
| | C:\Windows\system32\lib3.dll |

Performance measuring module 108 obtains the information regarding the booting stages and booting procedures of the booting at 9 AM and records them in the performance database 104, as shown in Tables 3A and 3B. Then Performance measuring module 108 obtains the information regarding the booting stages and booting procedures of the booting at 4 PM and records them in the performance database 104, as shown in Tables 4A and 4B.

TABLE 3A
(Table of booting stages, at 9 AM)

| | Starting | |
|---|---|---|
| Booting Stage | Time | Ending Time |
| PreSMSS | 0.00 | 10.06 |
| SMSSInit | 10.06 | 16.37 |
| WinlogonInit | 16.37 | 21.83 |
| . . . | | |

TABLE 3B
(Table of booting procedures, at 9 AM)

| | Starting | Ending | |
|---|---|---|---|
| Procedure | Time | Time | Accessed Files |
| Reminder | 32.18 | 47.35 | C:\Windows\system32\p1.exe |
| | | | C:\Windows\system32\lib1.dll |
| ccApp | 34.30 | −1 | C:\Windows\system32\p2.exe |
| | | | C:\Windows\system32\ntdll.dll |

TABLE 4A
(Table of booting stages, at 4 PM)

| | Starting | Ending |
|---|---|---|
| Booting Stage | Time | Time |
| PreSMSS | 0.00 | 11.03 |
| SMSSInit | 11.03 | 20.22 |
| WinlogonInit | 20.22 | 70.86 |
| . . . | | |

TABLE 4B
(Table of booting procedures, at 4 PM)

| | Starting | Ending | |
|---|---|---|---|
| Procedure | Time | Time | Accessed Files |
| Reminder | 32.18 | 48.35 | C:\Windows\App1\p1.exe |
| | | | C:\Windows\system32\lib1.dll |
| | | | C:\Windows\system32\lib2.dll |
| ccApp | 35.30 | −1 | C:\Windows\App2\p2.exe |
| | | | C:\Windows\system32\ntdll.dll |
| Updater | 12.01 | 18.33 | C:\Vendor3\App3\p3.exe |
| | | | C:\Windows\system32\lib3.dll |

Table 3A shows the starting time and the ending time of the booting stages such as “PreSMSS”, “SMSSInit”, or “WinlogonInit”; Table 3B shows the starting time, the ending time, and the accessed files of booting procedures such as “Reminder” or “ccApp”. Note that the procedure having the ending time “−1” is a resident procedure, which keeps running and will not be ended after the booting of the computer 10 is completed.

Next, the performance analyzing module 110 compares the contents in Table 3A with in Table 4A, particularly, compares the corresponding booting stages (e.g., SMSSInit), to determine if the booting at 4 PM is slower than the booting at 9 AM.

In Table 4A, the starting time “11.03” for the stage SMSSInit is subsequent to the starting time “10.06” for the same stage in Table 3A. Meanwhile, the time required to complete the stage SMSSInit “9.19” in Table 4A is longer than “6.31” in Table 3A for 45.64%. Similarly, the starting time for the stage WinlogonInit is delayed for 23.5%, and the time to complete the stage increases for 827.5%. Based on the a predetermined threshold of 10%, the performance analyzing module 110 accordingly concludes the booting is slower and the performance is getting lower, and the module 110 takes a further analysis to find out which Application causes this problem.

In this example, the performance analyzing module 110 further compares the contents in Table 3B with in Table 4B and finds an additional procedure “Updater” in the booting at 4 PM. Application comparing module 112 further compares the procedure “Updater” with Table 1 (a table of application installations) concluding that Application 3 is related to the procedure “Updater” and reports this conclusion to the user in a prompt message. Therefore the user can be aware of that the installation of Application 3 may slow down the booting and determine if he likes to uninstall Application 3.

Alternatively, the performance analyzing module 110 further compares the contents in Table 3B with in Table 4B and finds additional files accessed in each procedure in the booting at 4 PM, e.g., “C:\Windows\system32\lib2.dll” for the procedure “Reminder” or “C:\Vendor3\App3\p3.exe” and “C:\Windows\system32\lib3.dll” for the procedure “Updater”. Application comparing module 112 further compares these additional files with Table 2 (a table of application files), concluding that Applications 1 and 3 are related to the additionally accessed files and reports this conclusion to the user in a prompt message. Therefore the user can be aware of that the installation of Applications 1 and 3 may slow down the booting and determine if he likes to uninstall the Applications 1 and 3. Note that the alternative approaches mentioned above could be adopted together, so that the user can be aware of all potentially problematic Applications (Applications 1 and 3 in this example).

In another situation, if the application comparing module 112 cannot find a match in the additionally accessed files and the Applications recorded in Table 2, the application comparing module 112 will conclude that the procedure which accessed these additional files are “unknown” procedures and that the computer system 10 may have unknown or malicious Applications. Therefore the application comparing module 112 will report this finding to the user and suggests a virus- or spyware-scan.

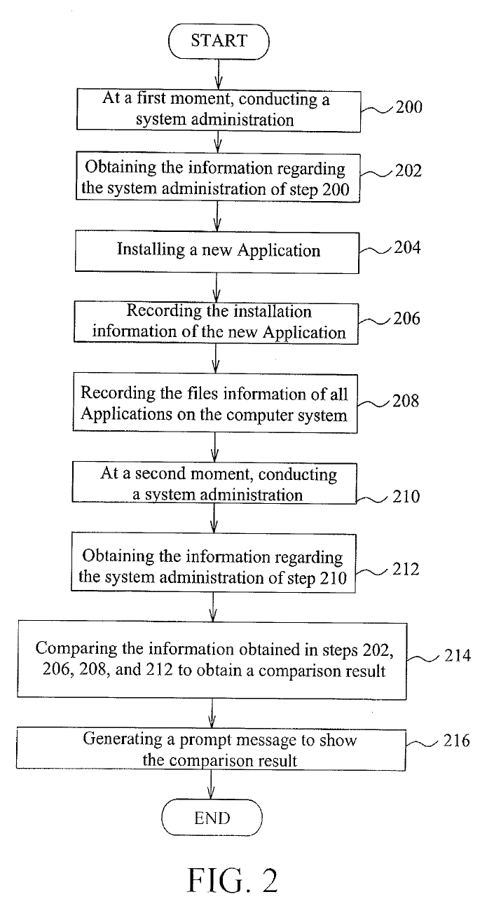

FIG. 2 is a flowchart illustrating a method administrating the computer system 10. In step 200, at a first moment, the computer system 10 conducts a system administration. The system administration could be a “booting” or a “shutting-down”, and the “shutting-down” includes “power off”, “standby”, and “hibernation”. The step 202 is to obtain the information regarding the system administration of step 200, as shown in Tables 3A and 3B.

In step 204, an Application is newly installed on the computer system 10, and in step 206, the installation information of this new Application is recorded in Table 1, for example. Further in step 208, the files information of all Applications installed on the computer system 10 is recorded in Table 2, for example.

In step 210, at a second moment, the computer system 10 conducts the system administration again. The step 212 is to obtain the information regarding the system administration of step 210, as shown in Tables 4A and 4B.

Then step 214 is to compare the information obtained in steps 202, 206, 208, and 212 to obtain a comparison result indicating which Application results in longer time to complete the system administration. In step 216, a prompt message is generated to show the comparison result to the user so that he can decide if he likes to remove the Application indicated in step 214.

The present invention also discloses a computer readable medium embodying computer code on a computer system 10. The computer code comprising computer executable instructions configured to perform the method illustrated in FIG. 2.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, the present invention may take the form of a computer program product embodied in any tangible medium of expression having computer-readable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A method for administrating a computer system, at least a first application being installed on said computer system, said method comprising:
(a) at a first moment, said computer system conducting a first system administration;
(b) obtaining the information regarding said first system administration conducted at said first moment as the first information;
(c) at a second moment, said computer system conducting a second system administration;
(d) obtaining the information regarding said second system administration conducted at said second moment as the second information;
(e) comparing said second information with said first information to obtain a comparison result; and
(f) generating a prompt message based on said comparison result.

2. A method according to claim 1, wherein said first information contains the time required to complete said first system administration as well as stages and the accessed files in said first system administration;
wherein said second information contains the time required to complete said second system administration as well as stages and the accessed files in said second system administration;
wherein in step (e) if the time required to complete said second system administration is longer than the time required to complete said first system administration, further comparing accessed files in a corresponding stage in said first system administration with those in said second system administration, in order to determine one or more additional accessed files in said corresponding stage in said second system administration.

3. A method according to claim 2, wherein in step (e) further determining a file related to said first application among said additional accessed files, and in step (f) showing said first application in said prompt message.

4. A method according to claim 2, wherein said time required to complete said first system administration includes the time required to complete each stage of said first system administration;
wherein said time required to complete said second system administration includes the time required to complete each stage of said second system administration.

5. A method according to claim 2, wherein a second application is installed additionally in said computer system after said first moment but before said second moment.

6. A method according to claim 5, wherein said second information contains the time required to complete said second system administration as well as one or more files related to said second application.

7. A method according to claim 6, wherein in step (e) said comparison result indicates whether said files related to said second application are accessed in said second system administration.

8. A method according to claim 5, wherein said first information contains the time required to complete said first system administration as well as stages and the accessed files in said first system administration;
wherein said second information contains the time required to complete said second system administration as well as stages and the accessed files in said second system administration;
wherein in step (e) if the time required to complete said second system administration is longer than the time required to complete said first system administration, further comparing the accessed files in a corresponding stage in said first system administration with those in said second system administration, in order to determine one or more additional accessed files in said corresponding stage in said second system administration, and further to determine among said additional accessed files, files related to said second application; and
wherein in step (f) showing said second application in said prompt message.

9. A method according to claim 1, wherein said first information contains the time required to complete said first system administration as well as stages and the accessed files in said first system administration;
wherein said second information contains the time required to complete said second system administration as well as stages and the accessed files in said second system administration;
wherein in step (e) if the time required to complete said second system administration is longer than the time required to complete said first system administration, further comparing the accessed files in a corresponding stage in said first system administration with those in said second system administration, in order to determine one or more additional accessed files in said corresponding stage in said second system administration, and further to determine among said additional accessed files, no file related to applications intentionally installed in said computer system; and
wherein in step (f) warning the user of unknown applications by said prompt message.

10. A method according to claim 1, wherein said first system administration and said second system administration are both carried out as the booting or the shutting-down of said computer system.

11. A computer readable medium embodying computer code on a computer system, at least a first application being installed in said computer system, said computer code comprising computer executable instructions configured for:
(a) at a first moment, said computer system conducting a first system administration;
(b) obtaining the information regarding said first system administration conducted at said first moment as the first information;
(c) at a second moment, said computer system conducting a second system administration;
(d) obtaining the information regarding said second system administration conducted at said second moment as the second information;
(e) comparing said second information with said first information to obtain a comparison result; and
(f) generating a prompt message based on said comparison result.

12. A computer readable medium according to claim 11, wherein said first information contains the time required to complete said first system administration as well as stages and the accessed files in said first system administration;
wherein said second information contains the time required to complete said second system administration as well as stages and the accessed files in said second system administration;
wherein in step (e) if the time required to complete said second system administration is longer than the time required to complete said first system administration, further comparing accessed files in a corresponding stage in said first system administration with those in said second system administration, in order to determine one or more additional accessed files in said corresponding stage in said second system administration.

13. A computer readable medium according to claim 12, wherein in step (e) further determining a file related to said first application among said additional accessed files, and in step (f) showing said first application in said prompt message.

14. A computer readable medium according to claim 12, wherein said time required to complete said first system administration includes the time required to complete each stage of said first system administration;
wherein said time required to complete said second system administration includes the time required to complete each stage of said second system administration.

15. A computer readable medium according to claim 12, wherein a second application is installed additionally in said computer system after said first moment but before said second moment.

16. A computer readable medium according to claim 15, wherein said second information contains the time required to complete said second system administration as well as one or more files related to said second application.

17. A computer readable medium according to claim 16, wherein in step (e) said comparison result indicates whether said files related to said second application are accessed in said second system administration.

18. A computer readable medium according to claim 15, wherein said first information contains the time required to complete said first system administration as well as stages and the accessed files in said first system administration;
wherein said second information contains the time required to complete said second system administration as well as stages and the accessed files in said second system administration;
wherein in step (e) if the time required to complete said second system administration is longer than the time required to complete said first system administration, further comparing the accessed files in a corresponding stage in said first system administration with those in said second system administration, in order to determine one or more additional accessed files in said corresponding stage in said second system administration, and further to determine among said additional accessed files, files related to said second application; and
wherein in step (f) showing said second application in said prompt message.

19. A computer readable medium according to claim 11, wherein said first information contains the time required to complete said first system administration as well as stages and the accessed files in said first system administration;
wherein said second information contains the time required to complete said second system administration as well as stages and the accessed files in said second system administration;
wherein in step (e) if the time required to complete said second system administration is longer than the time required to complete said first system administration, further comparing the accessed files in a corresponding stage in said first system administration with those in said second system administration, in order to determine one or more additional accessed files in said corresponding stage in said second system administration, and further to determine among said additional accessed files, no file related to applications intentionally installed in said computer system; and
wherein in step (f) warning the user of unknown applications by said prompt message.

20. A computer readable medium according to claim 11, wherein said first system administration and said second system administration are both carried out as the booting or the shutting-down of said computer system.
